(19) United States
(12) Patent Application Publication
(10) Pub. No.: US 2012/0146433 A1
(43) Pub. Date: Jun. 14, 2012

(54) LINEAR VIBRATOR

(75) Inventors: Seung Hyeon Jeong, Seoul (KR); Joon Choi, Gyunggi-do (KR)

(73) Assignee: SAMSUNG ELECTRO-MECHANICS CO., LTD., Gyunggi-do (KR)

(21) Appl. No.: 13/007,040

(22) Filed: Jan. 14, 2011

(30) Foreign Application Priority Data
Dec. 10, 2010 (KR) 1020100126012

(51) Int. Cl. H02K 33/00

(52) U.S. Cl. 310/25

(57) ABSTRACT

Disclosed herein is a linear vibrator for generating vibration in a mobile communication terminal, a portable terminal, and a photographing apparatus, including: a stator part including a bracket, coils connected to the bracket and a printed circuit board connected to the bracket and applying power to the coils; and a vibrator part configured of a magnet opposite to the coils, a yoke connected to the magnet and a weight body connected to the yoke, wherein the weight body has a cutting part formed by cutting a portion thereof.

### CROSS REFERENCE TO RELATED APPLICATION

This application claims the benefit of Korean Patent Application No. 10-2010-0126012, filed on Dec. 10, 2010, entitled “Linear Vibrator”, which is hereby incorporated by reference in its entirety into this application.

### BACKGROUND OF THE INVENTION

1. Technical Field

The present invention relates to a linear vibrator.

2. Description of the Related Art

Generally, a mobile communication terminal, a portable terminal, and a photographing apparatus are mounted with vibration generating apparatuses in order to provide vibration to users in various objects and forms. One of them is a linear vibrator.

A general linear vibrator includes a stator part including coils and a vibrator part including a magnet opposite to the coils and a weight body, and linearly vibrates by electromagnetic induction of the coils and the magnet.

More specifically, the linear vibrator vibrates, while the vibrator mounted on a spring vertically or horizontally performs a linear motion due to electromagnetic force between the magnet and the coils. Therefore, the linear vibrator has less friction and abrasion as compared to a vibration motor, thereby having a long life span. In addition, the linear vibrator can be compact, thereby having been currently developed in various shapes.

A linear vibrator, which is a component converting electrical energy into mechanical vibration using a principle of generating electromagnetic force, is mounted in electronic apparatuses such as the mobile communication terminal, the portable terminal, the photographing apparatus, a game machine, and the like, to be used for notifying silent reception and transferring vibration.

In accordance with the recent trend of compactness and slimness in the mobile communication terminal, the portable terminal and the photographing apparatus, the linear vibrator mounted therein has a compact size and a multi-function, correspondingly. According to the prior art, internal components configuring the vibrator part and the stator part have been coupled to each other in an internal space of the linear vibrator at high density and with high integration, such that interference has been caused between the internal components even with a small external shock.

Accordingly, the interference between the internal components has caused abnormal vibrating sound, which departs from the original purpose of a silent alarm notifying reception with silence of a device.

In addition, an abrasion phenomenon due to friction and the noise by the interference between the internal components have been generated even during driving of the linear vibrator.

### SUMMARY OF THE INVENTION

The present invention has been made in an effort to provide a linear vibrator preventing an abrasion phenomenon due to friction and abnormal vibrating sound and noise caused by interference between internal components generated due to external shocks or during driving thereof.

A linear vibrator according to a first preferred embodiment of the present invention includes: a stator part including a bracket, coils connected to the bracket and a printed circuit board connected to the bracket and applying power to the coils; and a vibrator part configured of a magnet opposite to the coils, a yoke connected to the magnet and a weight body connected to the yoke, wherein the weight body has a cutting part formed by cutting a portion thereof.

The cutting part of the weight body may be formed at a position opposite to the printed circuit board.

The vibrator part may further include a plate yoke connected to a lower portion of the magnet.

The vibrator part may further include a magnetic fluid coupled to an outer peripheral surface of the magnet.

The linear vibrator may further include a case having an internal space formed therein to include the stator part and the vibrator part therein and covering the bracket.

The vibrator part may further include an elastic member configured of an upper end connected to the case and a lower end connected to an upper portion of the yoke to elastically support a linear vibration movement of the vibrator.

The elastic member may have a damper formed on a surface opposite to the case.

The stator part may further include a damper mounted on the bracket and opposite to the magnet of the vibrator part.

### BRIEF DESCRIPTION OF THE DRAWINGS

FIG. 1 is a cross-sectional view of a linear vibrator according to a preferred embodiment of the present invention;

FIG. 2 is an exploded perspective view of a linear vibrator according to a preferred embodiment of the present invention; and

FIG. 3 is a plan view of a printed circuit board according to a preferred embodiment of the present invention.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc., can be used to describe various components, but the components are not to be construed as being limited to the terms. The terms are only used to differentiate one component from other components. Further, when it is determined that the detailed description of the known art related to the present invention may obscure the gist of the present invention, a detailed description thereof will be omitted.

Hereinafter, preferred embodiments of the present invention will be described in detail with reference to the accompanying drawings.

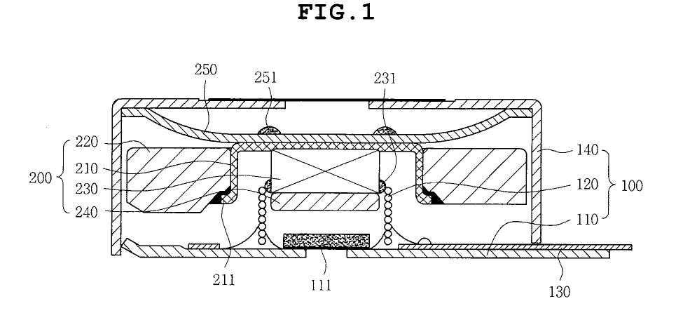

FIG. 1 is a cross-sectional view of a linear vibrator according to a preferred embodiment of the present invention. As shown in FIG. 1, a linear vibrator according to a preferred embodiment of the present invention includes a stator part 100 including a bracket 110, coils 120 and a printed circuit board 130, and a vibrator part 200 including a yoke 210, a weight body 220 and a magnet 230.

More specifically, the vibrator part 200 of the linear vibrator according to a preferred embodiment of the present invention may further include a plate yoke 240, a magnetic fluid 231, and an elastic member 250.

In addition, a case 140 including the stator part 100 and the vibrator part 200 and having an internal space formed therein in order to protect internal components thereof from electromagnetic force generated by electric force of the coils 120 and magnetic force of the magnet 230 and shocks from the outside may be coupled to an upper surface of the bracket 100.

In addition, the bracket 110 is made of a non-magnetic material or a weak magnetic material so as not to have an influence on driving of the vibrator part 200.

As shown in FIG. 1, the coils 120 are connected to the bracket 110, and the printed circuit board 130 is connected to the bracket 110 in order to apply current to the coils 120. According to a preferred embodiment of the present invention, the printed circuit board 130 may be preferably configured of a flexible printed circuit board (FPCB).

In addition, the magnet 230 is connected to a lower portion of the yoke 210 to be opposite to the coils 120, and a protrusion 211 to which the weight body 220 is connected is formed on an outer peripheral surface of the yoke 210.

Further, the magnetic fluid 231 is formed on an outer peripheral surface of the magnet 230 and the plate yoke 240 is coupled to a lower surface thereof.

In addition, the bracket 110 may be formed with a damper 111 being opposite to the magnet 230 and preventing noise and abrasion generated due to contact between the bracket 110 and the magnet 230.

An upper end of the elastic member 250 is connected to the case 140, and a lower end thereof is connected to the yoke 210 to elastically support a linear vibration movement of the vibration part 200.

Particularly, the elastic member 250 is connected to the vibrator part 200, such that the maximum displacement occurs at a resonance point when power frequency is applied thereto.

In addition, the elastic member 250 has a damper 251 formed on a surface opposite to the case 140 to prevent noise and abrasion generated due to contact between the vibrator part 200 and the case 140 in the case in which the vibrator part 200 performs the linear vibration movement.

Accordingly, when the current is applied to the coils 120 through the printed circuit board 130, the vibrator part 200 is vertically driven by the electromagnetic force generated by the electric force formed around the coils 120 and the magnetic force of the magnet 230, and the vibration is generated by the weight body 220 of the vibrator part 200 connected to the protrusion 211 formed on the outer peripheral surface of the yoke 210.

In addition, the elastic member 250 is coupled to the case 140 of the stator part 100 to serve to elastically support the vibration part 200 when the vibrator part 200 performs the linear vibration movement.

However, since the internal components of the linear vibrator are connected at high density in accordance with compactness and slimness of the linear vibrator, an excessive linear vibration movement of the vibrator part leads to a contact between the vibrator part and the stator part to cause abnormal vibrating sound and an abrasion phenomenon.

In addition, the vibration part and the stator part are also mutually interfered by the shocks applied from the outside to cause the abnormal vibrating sound and the abrasion phenomenon.

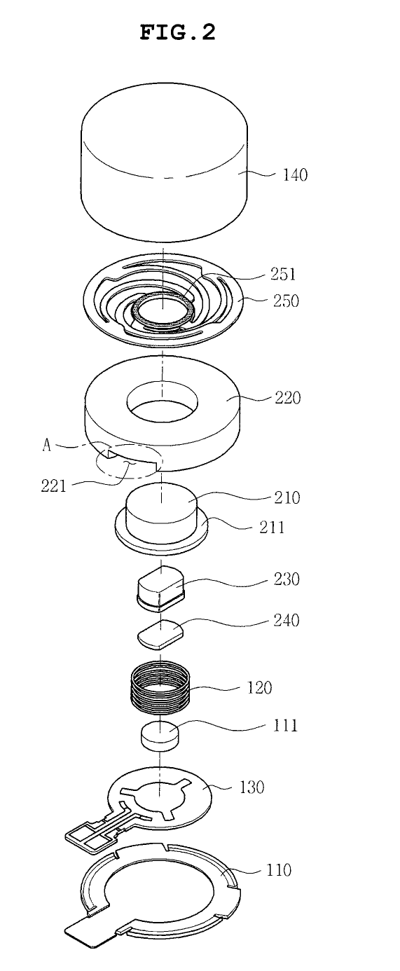

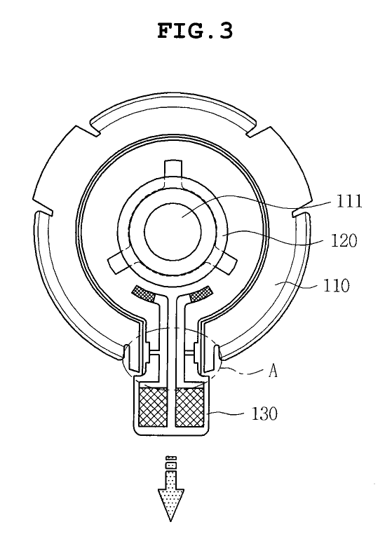

In order to prevent contact between the vibrator part 200 and the printed circuit board 130 when the vibrator part 200 performs the linear vibration movement in which it is driven vertically in the case 140 by the electromagnetic force, a cutting part 221 of the weight body 220 is preferably formed at a position opposite to the printed circuit board 130, as shown in a section A of FIGS. 2 and 3.

In addition, the weight body 220 may have cutting parts formed at any positions at which the interference phenomenon is generated, corresponding to the internal components or elements of the linear vibrator, in addition to the bracket 110, the coil 120, the elastic member 250 and the case 140, that is, at various positions according to volume and size of the weight body 220.

When the vibrator part 200 performs the excessive linear vibration movement, the weight body 220 is formed with the cutting part 221 to prevent contact between the weight body 220 and the printed circuit board 130, such that the abnormal vibrating sound and the abrasion phenomenon are not caused.

The linear vibrator according to the preferred embodiments of the present invention forms a cutting part in the weight body of the vibrator part, thereby making it possible to optimize weight of the weight body.

In addition, the interference between the printed circuit board and the weight body and the interference due to the contact between the weight body and the internal components generated due to the shocks applied from the outside or during the driving the mobile communication terminal, the portable terminal, and the photographing apparatus are prevented, thereby improving reliability of product life span, simultaneously with minimizing generation of the abnormal vibrating sound and the noise of the mobile communication terminal, the portable terminal, and the photographing apparatus.

Although the preferred embodiments of the present invention have been disclosed for illustrative purposes, they are for specifically explaining the present invention and thus a linear vibrator according to the preferred embodiment of the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A linear vibrator comprising:
a stator part including a bracket, coils connected to the bracket and a printed circuit board connected to the bracket and applying power to the coils; and
a vibrator part configured of a magnet opposite to the coils, a yoke connected to the magnet and a weight body connected to the yoke,
wherein the weight body has a cutting part formed by cutting a portion thereof.

2. The linear vibrator as set forth in claim 1, wherein the cutting part of the weight body is formed at a position opposite to the printed circuit board.

3. The linear vibrator as set forth in claim 1, wherein the vibrator part further includes a plate yoke connected to a lower portion of the magnet.

4. The linear vibrator as set forth in claim 1, wherein the vibrator part further includes a magnetic fluid provided to an outer peripheral surface of the magnet.

5. The linear vibrator as set forth in claim 1, further comprising a case having an internal space formed therein to include the stator part and the vibrator part therein and covering the bracket.

6. The linear vibrator as set forth in claim 5, wherein the vibrator part further includes an elastic member configured of an upper end connected to the case and a lower end connected to an upper portion of the yoke to elastically support a linear vibration movement of the vibrator.

7. The linear vibrator as set forth in claim 6, wherein the elastic member has a damper formed on a surface opposite to the case.

8. The linear vibrator as set forth in claim 1, wherein the stator part further includes a damper mounted on the bracket and opposite to the magnet of the vibrator part.
